(19) United States
(12) Patent Application Publication
(10) Pub. No.: US 2023/0204735 A1
(43) Pub. Date: Jun. 29, 2023

(54) DETECTION APPARATUS AND METHOD

(71) Applicant: Ningbo ABAX Sensing Electronic Technology Co., Ltd., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City (CN)

(21) Appl. No.: 17/924,500

(22) PCT Filed: Jun. 22, 2020
(86) PCT No.: PCT/CN2020/097331

§ 371 Date: Nov. 10, 2022

(30) Foreign Application Priority Data
May 13, 2020 (CN) 202010403369.2

(51) Int. Cl. G01S 7/4911; G01S 17/08; G01S 7/481

(52) U.S. Cl. CPC G01S 7/4911; G01S 7/4816; G01S 17/08

(57) ABSTRACT

Disclosed are a detection apparatus and a detection method using the detection apparatus. The apparatus comprises: a light source ; a receiving part containing a photoelectric conversion module, with the receiving part further containing a first circuit for receiving a first modulation signal, and a second circuit for receiving a second modulation signal; a controller, which can control the light source to emit irradiation light and generates a plurality of delay control phase signals in different phases, with first and second modulation circuits of the receiving part outputting electrical signals corresponding to at least one receiving control signal in the same phase; and an information acquisition unit for acquiring target information of a detected object according to the electrical signals of the receiving control signal in the same phase that are respectively obtained by the two circuits.

### CROSS REFERENCE TO RELATED APPLICATIONS

The present application claims priority to Chinese Patent Application No. CN202010403369.2, titled “DETECTION APPARATUS AND METHOD”, filed on May 13, 2020 with the Chinese Patent Office, which is incorporated herein by reference in its entirety.

### FIELD

The present disclosure relates to the field of detection technology, and in particular to a detection device and a detection method.

### BACKGROUND

In the field of detection technology, more and more technologies are continuously developed. In order to ensure that a target in an application field such as the image acquisition or the distance measurement can be detected efficiently and fast, more and more devices are designed to have a multi-tap (two or more than two) structure, which may work in different time periods to read photo-generated electrons generated in a connected pixel unit. In the case that the multi-tap is reasonably arranged, the receiving portion in the chip or formed by the multi-tap can efficiently work. However, there is a deviation between signals taken by different taps due to various factors. Even for the photo-generated electrons generated by incidence of the same return light, there is a difference between output values of the different taps. This phenomenon has an important impact on the image acquisition or the distance measurement.

In recent years, with the development of semiconductor technology, progress has been made on miniaturization of a distance measurement module for measuring a distance to an object. For example, the distance measurement module can be installed in a mobile terminal such as a so-called smart phone, which is a small-size information processing device having a communication function. With the advancement of technology, the Time of flight (TOF) method is most commonly used in the process of distance or depth information detection. The principle of the TOF is described as follows. A light pulse is continuously emitted to the object, and the light returned from the object is received by a sensor, and the distance to the object is obtained by detecting the flight (round-trip) time of the light pulse. In the TOF technology, a method in which the flight time of the light is directly measured is called the DTOF (direct-TOF) technology. In another method, the emitted light signal is periodically modulated, the phase delay of the reflected light signal relative to the emitted light signal is measured, and the flight time is calculated from the phase delay, which is called the ITOF (Indirect-TOF) technology. According to the different modes of modulation and demodulation, there exists a continuous wave (CW) modulation and demodulation mode and a pulse modulated (PM) modulation and demodulation mode. Further, high precision and high sensitivity of the distance detection can be achieved with the ITOF technology. Therefore, the ITOF technology has been widely used.

In order to achieve efficient measurement results and higher chip integration, the two-tap solution or a solution having more than two taps are used for the distance measurement. The distance information of the target may be obtained by the phase distance measurement method, for example, the simplest two-phase solution, Further, a three-phase solution, a four-phase solution or even a five-phase solution may be used to obtain the distance information. The following description is given by taking the four-phase solution as an example. The exposure is required for at least two times (to ensure the measurement accuracy, the exposure is usually required for four times), in order to complete the acquisition of four phase data and output a frame of depth image. In this case, it is difficult to obtain a higher frame rate. Further, in the process of different taps outputting the information, there is a difference between the results as described above. In order to ensure the result accuracy in the image acquisition or the image acquisition, a solution that can solve the above problems is urgently needed.

### SUMMARY

In view of the above, an object of the present disclosure is to provide a detection device and a detection method, to solve a technical problem that a detection distance of an existing detection device is not far enough.

In order to achieve the above object, solutions in the embodiments of the present disclosure are provided.

In a first aspect, a detection device is provided according to an embodiment of the present disclosure. The detection device includes: a light source, a receiving portion, a controller, and an information acquiring unit. The light source is operable to emit light to illuminate a detected object. The receiving portion includes a photoelectric conversion module. The receiving portion is configured to acquire a light amount of the light source reflected by the detected object. The photoelectric conversion module is configured to generate photo-generated electrons according to the received light amount. The receiving portion further includes a first circuit and a second circuit each configured to convert incident light into an electrical signal. The first circuit is configured to receive a first modulation signal, and the second circuit is configured to receive a second modulation signal. The first circuit and the second circuit are configured to generate respective electrical signals according to the first modulation signal and the second modulation signal. The controller is electrically connected to the light source to control the light source to emit light to illuminate the detected object, and the controller is further electrically connected to the receiving portion so that the receiving portion receives multiple receiving control signals having a same phase or different phases as the light signal emitted by the light source, and acquires electrical signals corresponding to at least one of the receiving control signals having the same phase respectively by the two circuits. The information acquiring unit configured to acquire target information of the detected object according to the electrical signals corresponding to the at least one of the receiving control signals having the same phase respectively acquired by the two circuits.

Optionally, the multiple receiving control signals having the same phase or different phases as the light signal emitted by the light source are four receiving control signals having different phases.

Optionally, in the process of acquiring the target information, the electrical signals corresponding to the receiving control signals having the same phase are at least summed.

Optionally, the multiple receiving control signals having the same phase or different phases including signals having four phases of 0°, 90°, 180° and 270°, and the light receiving portion is configured to acquire, for at least one of the receiving control signals having the phases, electrical signals corresponding to the reflected light of the same phase respectively by the two circuits.

Optionally, the two circuits respectively acquire different electrical signals corresponding to each phase of the multiple receiving control signals having the same phase or different phases.

Optionally, the first modulation signal and the second modulation signal are reciprocal to each other in at least part of a time period.

Optionally, the light source outputs the emitted light with a same duration for at least four times, and circuit modulation signals respectively corresponding to two receiving control signals having a phase difference of 180° are reciprocal signals.

Optionally, the circuit modulation signals respectively corresponding to the two receiving control signals having a phase difference of 90° have a first time interval, and are respectively converted into different electrical signals by the first circuit receiving the first modulation signal and the second circuit receiving the second modulation signal in the receiving portion.

Optionally, the first circuit and the second circuit are connected to a same pixel unit and receive the first modulation signal and the second modulation signal to generate respective electrical signals.

Optionally, the receiving portion includes multiple pixel units arranged in an array.

In a second aspect, a detection method is provided according to an embodiment of the present disclosure. The detection method is applied to the detection device as described in the first aspect. The detection method includes:
acquiring, by the receiving portion under the control of a control signal, the light amount of the light source reflected by the detected object, and generating, by the photoelectric conversion module in the receiving portion, corresponding photo-generated electrons according to the received light amount, where the receiving portion further includes the first circuit and the second circuit each configured to convert the incident light into the electrical signal, the first circuit is configured to receive the first modulation signal and the second circuit is configured to receive the second modulation signal, and where the first circuit and the second circuit are configured to generate respective electrical signals according to the first modulation signal and the second modulation signal;
controlling, by the controller, the light source to emit the light to illuminate the detected object, and controlling, by the controller, the receiving portion to receive the multiple receiving control signals having the same phase or different phases as the light signal emitted by the light source and acquire electrical signals corresponding to at least one of the receiving control signals having the same phase respectively by the two circuits; and
acquiring, by the information acquiring unit, the target information of the detected object according to the electrical signals corresponding to the at least one of the receiving control signals having the same phase respectively acquired by the two circuits.

Optionally, the multiple receiving control signals having the same phase or different phases as the light signal emitted by the light source are four receiving control signals having different phases.

Optionally, in the process of acquiring the target information, the electrical signals corresponding to the receiving control signals having the same phase are at least summed.

Optionally, the multiple receiving control signals having the same phase or different phases includes signals having four phases of 0°, 90°, 180° and 270°, and the light receiving portion acquires, for at least one of the receiving control signals having the phases, electrical signals corresponding to the reflected light of the same phase respectively by the two circuits.

Optionally, the two circuits respectively acquires different electrical signals corresponding to each phase of the multiple receiving control signals having the same phase or different phases.

Optionally, the first modulation signal and the second modulation signal are reciprocal to each other in at least part of a time period.

Optionally, the light source outputs the emitted light with a same duration for at least four times, and circuit modulation signals respectively corresponding to two receiving control signals having a phase difference of 180° are reciprocal signals.

Optionally, the circuit modulation signals respectively corresponding to the two receiving control signals having a phase difference of 90° have a first time interval, and are respectively converted into different electrical signals by the first circuit receiving the first modulation signal and the second circuit receiving the second modulation signal in the receiving portion.

Optionally, the first circuit and the second circuit are connected to a same pixel unit and receive the first modulation signal and the second modulation signal to generate respective electrical signals.

Optionally, the receiving portion includes multiple pixel units arranged in an array.

The present disclosure has the following beneficial effects.

A detection device and a detection method are provided according to embodiments of the present disclosure. The detection device includes: a light source, a receiving portion, a controller, and an information acquiring unit. The light source is operable to emit light to illuminate a detected object. The receiving portion includes a photoelectric conversion module. The receiving portion is configured to acquire a light amount of the light source reflected by the detected object. The photoelectric conversion module is configured to generate photo-generated electrons according to the received light amount. The receiving portion further includes a first circuit and a second circuit each configured to convert incident light into an electrical signal. The first circuit is configured to receive a first modulation signal, and the second circuit is configured to receive a second modulation signal. The first circuit and the second circuit are configured to generate respective electrical signals according to the first modulation signal and the second modulation signal. The controller is electrically connected to the light source to control the light source to emit light to illuminate the detected object, and the controller is further electrically connected to the receiving portion so that the receiving portion receives multiple receiving control signals having a same phase or different phases as the light signal emitted by the light source, and acquires electrical signals corresponding to at least one of the receiving control signals having the same phase respectively by the two circuits. The information acquiring unit configured to acquire target information of the detected object according to the electrical signals corresponding to the at least one of the receiving control signals having the same phase respectively acquired by the two circuits. In this way, the electrical signals corresponding to the receiving control signal of at least one same phase are respectively acquired by the two circuits in the receiving portion. In other words, the completely same emitted light is reflected by the target and received by different circuits, which may be understood as being obtained by different taps and processed in the subsequent circuit. The two electrical signal values of the same signal can be used to perform certain calculations, including taking the difference and other schemes to finally obtain more accurate information, so that the detector has the maximum accuracy improvement in the terms of the quality of the obtained image or the measured distance.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing functional modules of a detection device according to an embodiment of the present disclosure;

FIG. 2 is a schematic diagram showing an operation of a receiving portion according to an embodiment of the present disclosure;

FIG. 3 is a schematic diagram showing an operation of an information acquiring unit according to an embodiment of the present disclosure;

FIG. 4 is a schematic diagram showing timing control according to an embodiment of the present disclosure;

FIG. 5 is a schematic diagram showing timing control according to another embodiment of the present disclosure;

FIG. 6 is a schematic diagram showing timing control according to another embodiment of the present disclosure;

FIG. 7 is a schematic flowchart showing a detection method according to an embodiment of the present disclosure;

FIG. 8 is a schematic flowchart showing a detection method according to another embodiment of the present disclosure; and

FIG. 9 is a schematic flowchart showing a detection method according to another embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those of ordinary skill in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

FIG. 1 is a schematic diagram showing functional modules of a detection device according to an embodiment of the present disclosure. As shown in FIG. 1, the detection device includes: a light source 110, a controller 120, a receiving portion 130 and an information acquiring unit 140. The light source 110 may be configured as a unit or an array light source system that emits continuous light, which may be implemented by a semiconductor laser, an LED, or other light sources that can be pulsed. In a case that the semiconductor laser is used as the light source, a vertical-cavity surface-emitting laser VCSEL (Vertical-cavity surface-emitting laser) or an edge-emitting semiconductor laser EEL (edge-emitting laser) can be used, which is only exemplary and is not limited herein. Further, the waveform of the light outputted by the light source 110 is not limited herein, which may be a square wave, a triangular wave, a sine wave, or the like. The receiving portion 130 includes a photoelectric conversion module having a photoelectric conversion function, which may be implemented by a photo-diode (Photo-Diode, PD), which may be specifically a charge-coupled device (Charge-coupled Device, CCD), a complementary metal oxide semiconductor (Complementary Metal Oxide Semiconductor, CMOS), which is not limited herein.

The controller 120 is configured to control the light source to emit the emitted light for different times. When the receiving portion 130 has phase delays of 0°, 180°, 90° and 270° with the emitted light of the light source 100, the controller 120 controls the receiving portion to acquire the light reflected by the detected object 150 corresponding to the different phase delays. The reflected light forms incident light in the receiving portion 130, and is photoelectrically converted into different information by the receiving portion. In some cases, the 0° and 180° two-phase solution is also used to obtain the information of the detected object. In addition, the acquisition of the target information by the 0°, 120° and 240° three-phase solution is disclosed in some documents, and a five-phase delay solution is disclosed in even some documents, which is not specifically limited in the present disclosure. The acquired target information may be image information of the target, or distance information, contour information, and the like of the target, which is not specifically limited in the present disclosure. In order to illustrate the specific technical problems, the existing problems and solutions are described in detail by taking the four-phase time-of-flight distance acquisition solution as an example. The multi-tap structure may be a structure in which an independent tap is arranged for each phase. Four phase taps are connected to a pixel unit (may be directly connected or connected through an intermediate medium). Alternatively, two phases may share a tap, for example, 0° and 90° share a tap, 180° and 270° share a tap. With this design, not only reliable transmission of information can be achieved, but also the optimization of the pixel size design and layout structure can be ensured. The target information (such as the distance, depth, contour or image) can be efficiently obtained by connecting multiple taps to a pixel.

Based on the above, the light source 110 emits the emitted light, and the receiving portion 130 is controlled by the controller 120 to obtain the light reflected from the detected object 150 with a predetermined phase delay, for example, four different phase delays from the emitted light. The reflected light forms incident light in the receiving portion 130. In this solution, no special requirements are made for the light source, and the light emitted by the light source is the same light each time and there is no phase difference, avoiding the error caused by the adjustment of the luminous state parameters of the light source device during use. Further, the realization of the device is relative simple, which ensures the reliability of the entire detection device system. In this solution, the phase delay is implemented in the receiving portion and the controller. The controller may be integrated in the receiving portion to ensure the simplicity and efficiency of the system structure. In addition, the multi-phase delay receiving solution is adopted in the receiving portion, avoiding the need to emit light for each phase at the emitting end. For example, in the four-phase solution, target information with two phase delays of 0° and 180° may be acquired by one emission, so that the entire ranging system can achieve the efficient distance measurement. The light emitted by the light source 110 and reflected from the detected object 150 is converted into photo-generated electrons (or photo-generated charges) by a photoelectric conversion module in the receiving portion. Through the modulation by the taps, the photo-generated electrons or charges are transferred inside the device according to a first circuit or a second circuit (where the first circuit or the second circuit mentioned herein includes a charge or electron transfer channel inside the pixel). The photo-generated electrons or charges are respectively transmitted to different external physical circuits via a first electron transfer channel or a second electron transfer channel in the device (where the first circuit or the second circuit further includes a first physical circuit and a second physical circuit outside the pixel). Next, a physical operation (for example, using a charge storage unit, a capacitor, and the like) or a digital operation (for example, integrating a sensor and a computing unit into a chip) is performed in the pixel, or the physical operation or the digital operation is performed in a subsequent ADC circuit or other circuits, which is not limited in the present disclosure.

The following description is given by taking the four-phase two-tap structure as an example. For example, 0° and 90° share one tap, and 180° and 270° share one tap (in a actual operation, sharing a tap does not mean sharing a fixed tap, and the tap shared by the two phase delays may be exchanged with the other). The controller 120 controls the light source 110 to emit the emitted light. After the light is reflected from the detected object 150, the controller 120 controls the receiving portion 130 to receive the light with two phase delays, for example, two phase delays of 0° and 180° in the above four-phase solution. The photoelectric conversion module in the receiving portion 130 converts the light signal with the phase delay into photo-generated electrons in the pixel. The tap of the first circuit receives a first modulation signal to transfer the photo-generated electrons of the 0° phase that are converted by the photoelectric conversion module in the pixel to form an electrical signal, which is outputted by the first circuit. Further, the tap of the second circuit receives a second modulation signal to transfer the photo-generated electrons of the 180° phase that are converted by the photoelectric conversion module in the pixel to form an electrical signal, which is outputted by the second circuit. Alternatively, each phase delay corresponds to one tap. In the first circuit, 0° and 90° share a floating diffusion node (FD), and 180° and 270° share a floating diffusion node (FD). In the actual operation, sharing a floating diffusion node does not mean sharing a fixed floating diffusion node, and the floating diffusion node shared by the two phase delays may be exchanged with the other. In this embodiment, the electrical signals respectively corresponding to the phase delays of 0° and 180° may be obtained in one light source emission. In a next control of the controller, the reception is performed for the two phase delays of 90° and 270° in the four-phase solution, and the photoelectric conversion module in the receiving portion 130 converts the light signal with the phase delay into photoelectric electrons in the pixel. The tap of the first circuit receives the first modulation signal to transfer the photo-generated electrons of the 90° phase that are converted by the photoelectric conversion module in the pixel to form an electrical signal, which is outputted by the first circuit. Further, the tap of the second circuit receives a second modulation signal to transfer the photo-generated electrons of the 270° phase that are converted by the photoelectric conversion module in the pixel to form an electrical signal, which is outputted by the second circuit. In this case, the information corresponding to 90° and 270° is obtained at one time. Further, the controller 120 may control the light source 110 to output the emitted light, and control the reception for at least two phase delays of 0° and 180° in the four-phase solution. The photoelectric conversion module in the receiving portion 130 converts the light signal with the phase delay into photoelectric electrons in the pixel. The tap of the first circuit receives the first modulation signal to transfer the photo-generated electrons of the 180° phase that are converted by the photoelectric conversion module in the pixel to form an electrical signal, which is outputted by the first circuit. Further, the tap of the second circuit receives a second modulation signal to transfer the photo-generated electrons of the 0° phase that are converted by the photoelectric conversion module in the pixel to form an electrical signal, which is outputted by the second circuit. In this way, electrical signals corresponding to at least one of receiving control signals having the same phase are respectively obtained by the two circuits. In the final target information operation process, at least two electrical signals obtained by the two circuits may be operated to obtain target information. For example, for image or distance information, the following operations may be performed using the signals obtained by the two circuits.

$$\begin{matrix}f \left({0}^{∘}\right) \text{=} m f \left({0}^{∘} \_ 1\right) + n f \left({0}^{∘} \_ 2\right) \\ f \left({180}^{∘}\right) \text{=} l f \left({180}^{∘} \_ 1\right) + h f \left({180}^{∘} \_ 2\right)\end{matrix}$$

The results of the phase delays of 90° and 270° are obtained similarly, and may be corrected by an operation similar to the formula 1. The corrected result may be used to obtain the final target information. The corrected result may be an intermediate result and may be directly used in a specific expression of the final image or distance operation, which is not limited in the present disclosure. In the above formula, ƒ (0°) represents a final information result corresponding to the 0° phase that needs to be corrected, ƒ (0°_1) represents an information result corresponding to the 0° phase obtained by the first circuit, and ƒ (0°_2) represents an information result corresponding to the 0° phase obtained by the second circuit, where m, n, 1, and h each may be a correction coefficient valued in an interval [-1, 1].

In the above embodiment, the receiving phases whose phase delays are respectively 0° and 180° have a phase difference of 180°, the modulation signals corresponding to the first circuit and the second circuit for the two delayed receiving phases are reciprocal signals. That is, in a first time period, the first circuit or the second circuit outputs the electrical signal for the reception of the 0° phase delay, and neither the first circuit nor the second circuit outputs the electrical signal for the reception of the corresponding 180° delay on the pixel, and in another time period, the opposite operation is performed. The similar operation is performed for the receiving phases having a phase difference of 180° whose phase delays are respectively 90° and 270°. In this way, the circuit modulation signals respectively corresponding to the receiving phases having a phase difference of 180° are reciprocal signals, achieving the effect of signal reliability acquisition and system efficient operation while multiple phases share a tap or floating diffusion (FD) node or other circuit components. Phase information with a phase difference of 90° is acquired at a first time interval. This time interval is a self-adjusting time interval inside the system, which may be designed according to a reset sequence to ensure the reliability of the output of different phase signals.

The technical problems and solutions in multi-tap in the TOF distance measurement are further explained below. In a case that the charges are distributed to the first tap and the second tap according to the distance to the target, the depth representing the distance to the target may be calculated by using all eight detections signals (for each phase signal, the electrical signals corresponding to the phase delay are obtained by two circuits). Electrical information of different phases may be outputted by two different circuits, such as the accumulated charge amount signal. In the process of distance acquisition, a phase difference φ of the light signal shuttling between a lidar imaging radar and the target may be calculated based on 4 groups of integral charges. Taking sinusoidal modulated light as an example, the phase difference φ between the echo signal corresponding to the modulated light and the emitted signal is expressed as:

$$φ \text{=arctan} \left[\left({\text{Q}}_{90 °} {\text{- Q}}_{270 °}\right) / \left({\text{Q}}_{0 °} {\text{- Q}}_{180 °}\right)\right]$$

In the above formula 2, Q_{0°}, Q_{90°}, Q_{180°} and Q_{270°} respectively represent electrical signals converted by the receiver circuits corresponding to different phase delays. In combination with the relationship between the distance and the phase difference, the final distance result may be obtained.

$$d \text{=} \left(\text{c/2}\right) * \left[1 / \left(2 π f\right)\right] * φ$$

In the above formula 3, c represents the speed of light, and f represents the frequency of the laser light emitted by the light source 110. If the light emitted by the light source 110 is a square wave, the following different cases exist, and the final distance information is obtained according to the following calculation method.

In the case of Q_{0°}>Q_{180°} and Q_{90°}>Q_{270°},

$${\text{D}}_{c} = \frac{c}{2} ∗ \frac{1}{4 f} ∗ \left(\frac{{\text{Q}}_{90 °} - {\text{Q}}_{270 °}}{\left({\text{Q}}_{0 ° -} {\text{Q}}_{180 °}\right) + \left({\text{Q}}_{90 ° -} {\text{Q}}_{270 °}\right)}\right)$$

In the case of Q_{0°}<Q_{180°} and Q_{90°}>Q_{270°},

$${\text{D}}_{c} = \frac{c}{2} ∗ \frac{1}{4 f} ∗ \left(2 - \frac{{\text{Q}}_{90 °} - {\text{Q}}_{270 °}}{\left({\text{Q}}_{90 °} - {\text{Q}}_{270 °}\right) - \left({\text{Q}}_{0 °} - {\text{Q}}_{180 °}\right)}\right)$$

In the case of Q_{0°}<Q_{180°} and Q_{90°}<Q_{270°},

$${\text{D}}_{c} = \frac{c}{8 f} ∗ \left(2 + \frac{{\text{Q}}_{90 °} - {\text{Q}}_{270 °}}{\left({\text{Q}}_{90 °} - {\text{Q}}_{270 °}\right) + \left({\text{Q}}_{0 ° -} {\text{Q}}_{180 °}\right)}\right)$$

In the case of Q_{0°}>Q_{180°} and Q_{90°}<Q_{270°},

$${\text{D}}_{c} = \frac{c}{8 f} ∗ \left(4 - \frac{{\text{Q}}_{90 °} - {\text{Q}}_{270 °}}{\left({\text{Q}}_{90 ° -} {\text{Q}}_{270 °}\right) - \left({\text{Q}}_{0 ° -} {\text{Q}}_{180 °}\right)}\right)$$

In the above formulas 4 to 7 for the distance calculation in the case of the square wave, Q_{0°}, Q_{90°}, Q_{180°} and Q_{270°} respectively represent electrical signals converted by the receiver circuits corresponding to different phase delays, c represents the speed of light, and f represents the frequency of the laser light. In addition, in some special cases, the sine wave method is used by some companies to approximately calculate the distance in the case of the square wave. In the four-phase ranging, different circuits (including the charge transfer channel inside the pixel and the physical circuit outside the pixel) output signal results of different phase delays. However, in the actual use, due to the influences of the delay and offset of the column line and comparator, the results respectively obtained by the two circuits for the same phase received signal have differences. For example, the number of inherent deviation electrons with respect to Q_{0°} and Q_{180°} caused due to these influences are respectively ΔQ1 and ΔQ2. In this case, there is actually a certain deviation in the number of electrons obtained with respect to Q_{0°} and Q_{180°}. For example, the electrical signals corresponding to the four phase delays respectively obtained by the first circuit and the second circuit are expressed as follows.

$${\text{Q}}_{0 ° , r 1} {\text{= Q}}_{0 °} \text{+} Δ \text{Q1 ;} {\text{Q}}_{180 ° , r 2} \text{=} {\text{Q}}_{180 °} \text{+} Δ \text{Q2}$$

In the formula 8, Q_{0°, r1} represents a value of the electrical signal corresponding to the phase delay of 0° that is converted by the first circuit and actually substituted into the distance calculation formula, and Q_{0°} represents an ideal true value obtained without considering the difference between the first circuit and the second circuit under an ideal condition, and ΔQ1 represents a value of a deviation electrical signal generated when the first circuit performs conversion for the phase delay signal of 0°. In addition, in the formula 8, symbols in the electrical signal calculation expression corresponding to the phase delay of 180° represent the similar meaning to those in the expression corresponding to the phase delay of 0°, which are not repeated herein. The value of ΔQ1 may be expressed by a linear function or a high-order function, and may be simulated according to the actual situation. The deviation electrical signal is difficultly acquired in the actual practice. Therefore, under this condition, substituting the actual values of the electrical signals converted for different phases through different phase delays into the distance solving formula causes a certain deviation, resulting in inaccurate final distance calculation. In the solution of the present disclosure, in order to solve the above technical problem, two electrical signal values may be respectively acquired by the first circuit and the second circuit for each of the four different phase delays, and an arithmetic average method (or a similar algorithm) is used to obtain the electrical signal value finally substituted into the expression, which may be expressed as follows:

$$\begin{matrix}{\text{Q}}_{0 ° , r 1} {\text{= Q}}_{0 °} + Δ {\text{Q1; Q}}_{0 ° , r 2} {\text{= Q}}_{0 °} \text{+} Δ {\text{Q2; Q}}_{0 ° , r} \text{=} \left({\text{Q}}_{0 ° , r 1} + {\text{Q}}_{0 ° , r 2}\right) \text{/} 2 \\ {\text{Q}}_{180 ° , r 1} {\text{= Q}}_{180 °} \text{+} Δ {\text{Q1 ; Q}}_{180 ° , r 2} {\text{= Q}}_{180 °} \text{+} Δ {\text{Q2; Q}}_{180 ° , r} \text{=} \left({\text{Q}}_{180 ° , r 1} + {\text{Q}}_{180 ° , r 2}\right) \text{/2} \\ {\text{Q}}_{9 0 ° , r 1} {\text{= Q}}_{9 0 °} \text{+} Δ {\text{Q1 ; Q}}_{9 0 ° , r 2} {\text{= Q}}_{9 0 °} \text{+} Δ {\text{Q2; Q}}_{9 0 ° , r} \text{=} \left({\text{Q}}_{9 0 ° , r 1} + {\text{Q}}_{9 0 ° , r 2}\right) \text{/2} \\ {\text{Q}}_{2 7 0 ° , r 1} {\text{= Q}}_{2 7 0 °} \text{+} Δ {\text{Q1 ; Q}}_{2 7 0 ° , r 2} {\text{= Q}}_{2 7 0 °} \text{+} Δ {\text{Q2; Q}}_{2 7 0 ° , r} \text{=} \left({\text{Q}}_{2 7 0 ° , r 1} + {\text{Q}}_{2 7 0 ° , r 2}\right) \text{/2}\end{matrix}$$

That is, the signals respectively obtained by the two circuits are summed. By the sum operation, the results outputted from different circuits for the same phase are superimposed. Based on this, the influencing factors ΔQ1 and AQ2 are superimposed. Therefore, the difference between the results outputted by different circuits for the same phase is considered, and the result after the superposition is used in the subsequent distance calculation to obtain an accurate distance result, which is illustrated by means of the formula 4 in the case of the square wave detection.

In the case of Q_{0°}>Q_{180°} and Q_{90°}>Q_{270°},

$$\begin{matrix}{\text{D}}_{o} = \frac{c}{2} ∗ \frac{1}{4 f} ∗ \left(\frac{{\text{Q}}_{90 ° x} - {\text{Q}}_{270 ° x}}{\left({\text{Q}}_{0 ° x -} {\text{Q}}_{180 ° x}\right) + \left({\text{Q}}_{90 ° x} - {\text{Q}}_{270 ° x}\right)}\right) \\ = \frac{c}{2} ∗ \frac{1}{4 f} ∗ \left(\frac{{\text{Q}}_{90 °} + \frac{Δ \text{Q1 +} Δ \text{Q2}}{2} - \left({\text{Q}}_{270 °} + \frac{Δ \text{Q1+} Δ \text{Q2}}{2}\right)}{\begin{matrix}{\text{Q}}_{0 °} + \frac{Δ \text{Q1 +} Δ \text{Q2}}{2} - \left({\text{Q}}_{180 °} + \frac{Δ \text{Q1+} Δ \text{Q2}}{2}\right) + \\ {\text{Q}}_{90 °} + \frac{Δ \text{Q1+} Δ \text{Q2}}{2} - \left({\text{Q}}_{270 °} + \frac{Δ \text{Q1+} Δ \text{Q2}}{2}\right)\end{matrix}}\right)\end{matrix}$$

In the above formula 10, the result of the sum operation may be directly used in the final distance acquisition without averaging, and the final accurate distance information may be obtained by accumulating the physical capacitor charges or by the digital operation of the subsequent arithmetic circuit. In the calculation, due to the difference operation of different phases, the offset caused by the column line comparator or the like can be eliminated. Further, The transfer function mismatch caused by the difference of taps and other non-ideal factors can be removed. The offset charge caused by the transfer function mismatch may be classified as a linear or non-linear relationship, and the principle of the offset charge caused by the transfer function mismatch is similar to that of the charge difference caused by the offset, and a solution similar to that the most accurate value is obtained by performing modification using the values obtained by the two channels used in image sensing applications, as shown in the formula 1.

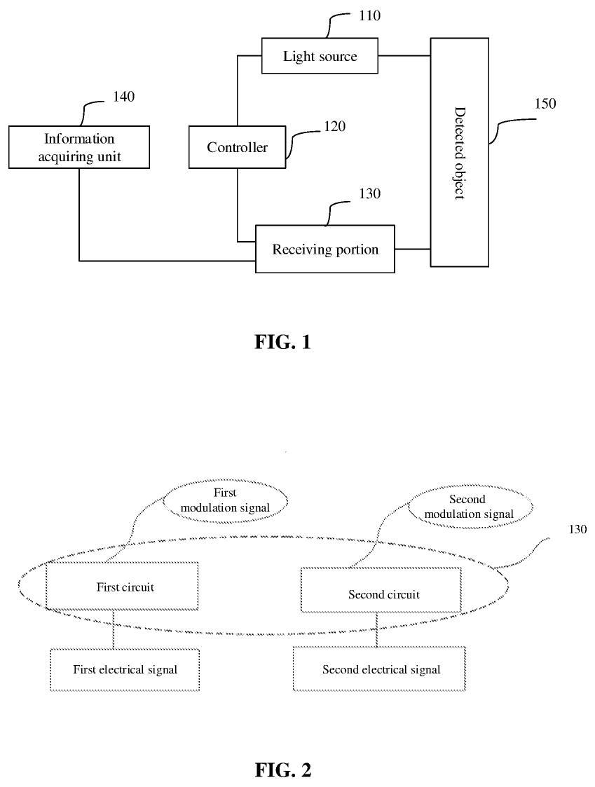

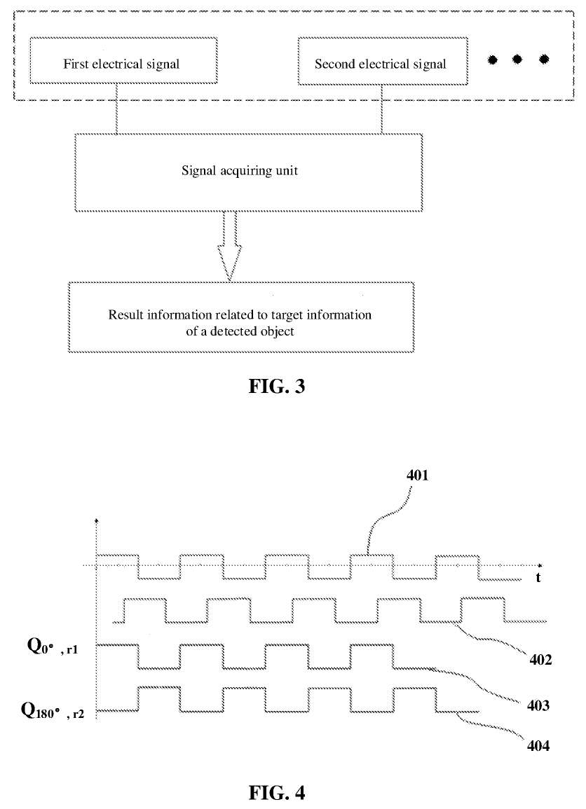

FIG. 2 is a schematic diagram showing a signal transmission and a connection relationship in the receiving portion 130. The receiving module 130 includes a first circuit and a second circuit. The first circuit may receive the first modulation signal. Under the control of this signal, the photo-generated electrons generated by the photoelectric conversion module inside the receiving portion 130 may be transferred via the first circuit to form a first electrical signal. As described above, the first circuit includes an electron transfer channel inside the pixel unit and a physical circuit outside the pixel unit. The first modulation signal may be a physical device or apparatus in the first circuit, such as a modulation gate. With the modulation signal generated by the controller, different photo-generated electrons are transferred via the first circuit or the second circuit to form a corresponding electrical signal. The basic principle of the second modulation signal acting on the second circuit is similar to that of the first circuit, which is not repeated herein. Further, the same pixel may be connected to more circuits to obtain more electrical signals, which is not repeated herein. The first circuit and the second circuit may be directly connected to the same pixel unit. By the time-division output of the pixel unit, more pixels can detect the detected object, which ensures the accuracy of detection. In addition, multiple such pixels form an entire pixel array, achieving efficient detection and targeted detection, as well as simultaneous detection for multiple targets.

FIG. 3 is a schematic diagram showing that result information of the detected object 150 is acquired by electrical signals obtained by different circuits (two circuits including the first circuit and the second circuit are used as examples for illustration herein, but the specific implementation is not limited to only two circuit output signals). The first electrical signal may include electrical signals outputted by the first circuit respectively corresponding to different phase delays. For example, the first electrical signal may include four electrical signals respectively corresponding to four phase delays of 0°, 90°, 180° and 270°. Similarly, the second electrical signal may include four electrical signals respectively corresponding to four phase delays of 0°, 90°, 180° and 270°. The information acquiring unit 140 acquires the final target information according to electrical signals corresponding to at least one of the receiving control signals having the same phase respectively acquired by the first circuit and the second circuit. The at least one of the receiving control signals having the same phase may be that for any one or more of the above four phases. The four-phase method can be used to realize the high efficiency of the distance measurement. Further, the method shown in the formula 1 may be used to correct the information obtained for at least part of the entire pixel array, to obtain the information required for the calculation of the final target information (such as distance or image). That is, the first electrical signal and the second electrical signal may be used in the calculation process of the final target information, or the final target information may be directly obtained by physical or digital calculation according to the four-phase distance measurement formula described above. The target information of the detected object directly obtained according to the electrical signal obtained by the first circuit or the second circuit is not limited to being directly used for the final calculation.

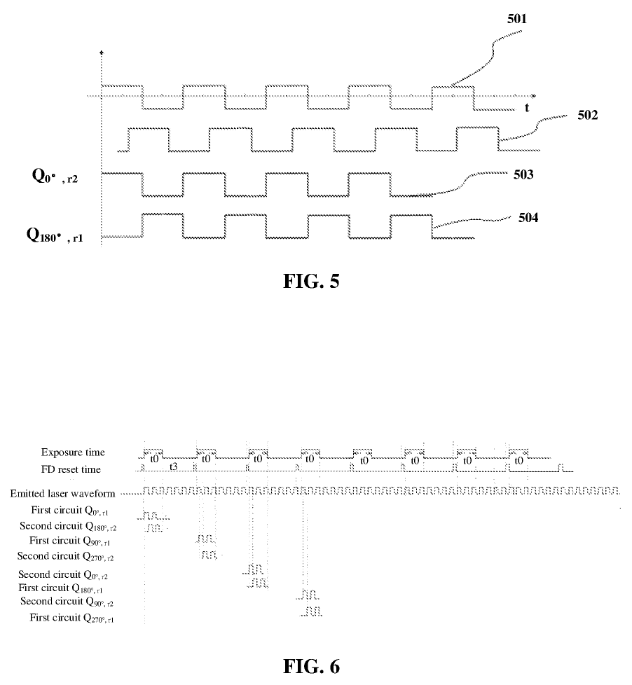

FIG. 4 and FIG. 5 are schematic diagrams showing that the detection is performed by a square emitted light emitted by the light source 110. The following description is given by the two-phase two-tap solution as an example. In FIG. 4 and FIG. 5, 401 and 501 represent the emitted light emitted by the light source for two times, and 402 and 502 each represent the echo signal obtained after the emitted light is reflected by the target. Further, Q_{0°, r1} represents a first electrical signal corresponding to the phase delay of 0° outputted by the first circuit, Q_{180°, r2} represents a second electrical signal corresponding to the phase delay of 180° outputted by the second circuit, Q_{0°, r2} represents a second electrical signal corresponding to the phase delay of 0° outputted by the second circuit, and Q_{0°, r1} represents a first electrical signal corresponding to the phase delay of 180° outputted by the first circuit. It can be clearly seen from FIG. 4 and FIG. 5 that, the phase delay of 0° refers to the receiver control signal controlled by the controller 130 without any delay from the emitted light, and other phase delays have the similar meaning to that of 0°. The obtained four electrical signals are processed in the information acquiring unit 140, and the final target information may be obtained in the manner described above.

FIG. 6 is a timing diagram showing the process of the two circuits acquiring the first signal and the second signal corresponding to each of different phases with the four-phase solution, in which the exposure time represents a duration of the receiving portion receiving the light reflected back from the detected object 150, the FD reset time represents the time for performing initialized reset on the pixel after the pixel receives the reflected light during the exposure time, converts the reflected light into photo-generated electrons by the photoelectric conversion unit, and transfers the outputted electrical signal by the first circuit or the second circuit, and the emitted laser refers to the output of emitted light at a certain frequency. The following description is given by taking a square wave as an example. Actually, the light source may emit waveforms such as a sine wave and a triangle wave. Further, Q_{0°, r1}, Q_{180°, r2}, Q_{90°, r1}, Q_{270°, r2}, Q_{0°, r2}, Q_{180°, r1}, Q_{90°, r2} and Q_{270°, r1} have similar meanings as those in FIG. 4 and FIG. 5, which are not explained in detail herein. With the four-phase solution, the high efficiency can be achieved in the distance measurement process. In addition, in the present disclosure, the obtained value for at least one phase is corrected, or the first electrical signal and the second electrical signal respectively outputted by two channels for each of the four phases are used to obtain the accurate distance information of the detected object according to the distance measurement formula in the case of the square wave, eliminating the influence of transfer function parameter mismatch or circuit offset and so on.

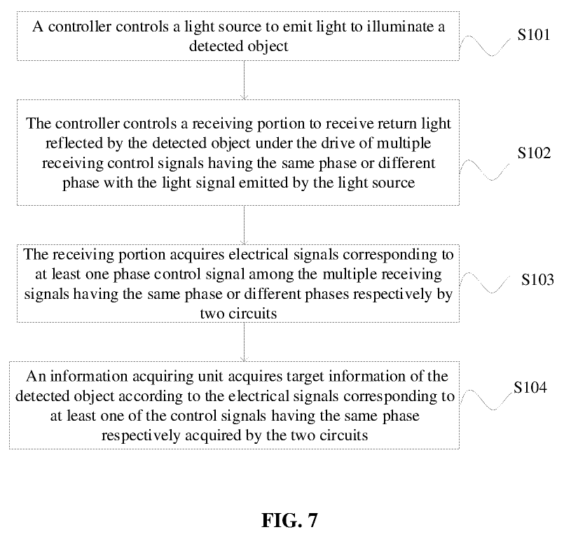

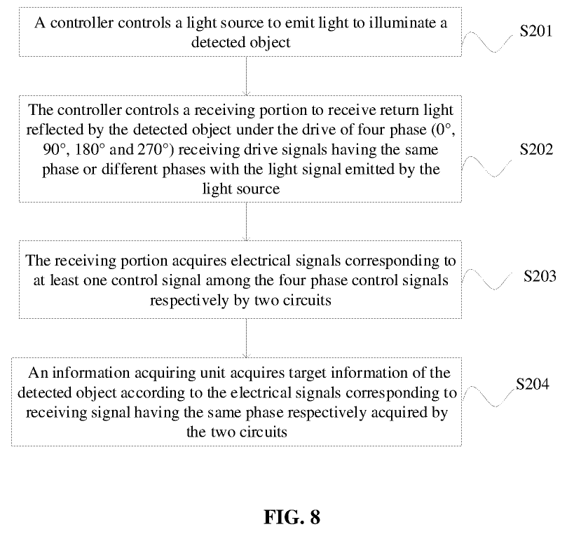

FIG. 7 illustrates steps of a method according to an embodiment of the present disclosure. In S101, the controller 120 controls the light source 110 to emit light, which may be a square wave, a triangular wave, or a sine wave, or the like, which is not specifically limited herein. The view field is illuminated under the action of the emitted light. The detected object 150 reflects the emitted light to form an echo of a reflected light. In S102, while controlling the light source to emit the emitted light, the controller 120 controls the receiver 130 to receive the echo of the reflected light by a control signal having a different phase delay from the light source 110. In S103, the receiving portion 130 acquires electrical signals corresponding to at least one of the multiple receiving signals having the same phase or different phases respectively by the two circuits. The multiple receiving signals having the same phase or different phases indicate that there are multiple delay control signals having the same phase or different phases. For example, the number of the delay control signals for the four-phase delay is four. In S104, the information acquiring unit 140 acquires the target information of the detected object 150 according to the electrical signals corresponding to at least one of the control signals having the same phase respectively acquired by the two circuits. The electrical signals corresponding to at least one control signal having the same phase may be used in the middle or final calculation of target information acquisition. The solution of using the electrical signal in a physical or digital manner has also been described before, which is not repeated herein.

FIG. 8 illustrates steps of a method according to another embodiment of the present disclosure, which are similar to the steps shown in FIG. 7. In FIG. 8, the process of acquiring the target information by using the four-phase solution is further defined. The implementation of the corresponding steps may refer to the steps in FIG. 7, which is not repeated herein.

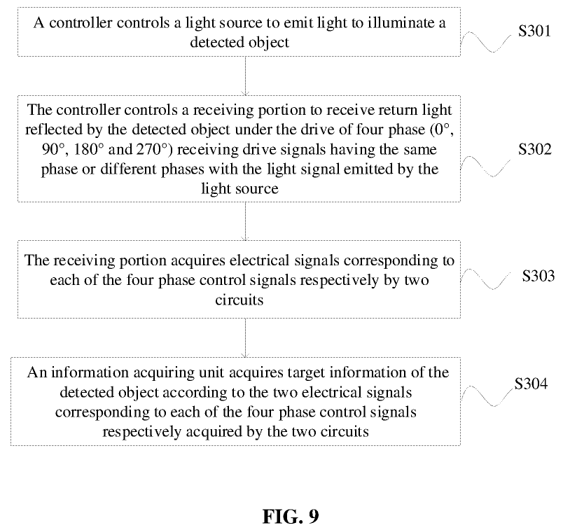

FIG. 9 illustrates steps of a method according to another embodiment of the present disclosure. Similar to the steps shown in FIG. 7 and FIG. 8, the process of acquiring the target information by using the four-phase solution is further defined in FIG. 9. Further, it is defined that corresponding electrical signals are respectively acquired by the two circuits for each phase of four delay phases, and the implementation of the corresponding steps may refer to the steps in FIG. 7, which is not repeated herein.

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a...” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A detection device, comprising:
a light source that is operable to emit light to illuminate a detected object;
a receiving portion comprising a photoelectric conversion module, wherein the receiving portion is configured to acquire a light amount of the light source reflected by the detected object, the photoelectric conversion module is configured to generate photo-generated electrons according to the received light amount, and wherein the receiving portion further comprises a first circuit and a second circuit each configured to convert incident light into an electrical signal, wherein the first circuit is configured to receive a first modulation signal, and the second circuit is configured to receive a second modulation signal, wherein the first circuit and the second circuit are configured to generate respective electrical signals according to the first modulation signal and the second modulation signal;
a controller, wherein the controller is electrically connected to the light source to control the light source to emit light to illuminate the detected object, and the controller is further electrically connected to the receiving portion so that the receiving portion receives a plurality of receiving control signals having a same phase or different phases as the light signal emitted by the light source, and acquires electrical signals corresponding to at least one of the receiving control signals having the same phase respectively by the two circuits; and
an information acquiring unit configured to acquire target information of the detected object according to the electrical signals corresponding to the at least one of the receiving control signals having the same phase respectively acquired by the two circuits.

2. The detection device according to claim 1, wherein the plurality of receiving control signals having the same phase or different phases as the light signal emitted by the light source are four receiving control signals having different phases.

3. The detection device according to claim 1, wherein in the process of acquiring the target information, the electrical signals corresponding to the receiving control signals having the same phase are at least summed.

4. The detection device according to claim 1, wherein the plurality of receiving control signals having the same phase or different phases comprise signals having four phases of 0°, 90°, 180° and 270°, and the light receiving portion is configured to acquire, for at least one of the receiving control signals having the phases, electrical signals corresponding to the reflected light of the same phase respectively by the two circuits.

5. The detection device according to claim 1, wherein the two circuits respectively acquire different electrical signals corresponding to each phase of the plurality of receiving control signals having the same phase or different phases.

6. The detection device according to claim 1, wherein the first modulation signal and the second modulation signal are reciprocal to each other in at least part of a time period.

7. The detection device according to claim 1, wherein the light source outputs the emitted light with a same duration for at least four times, and circuit modulation signals respectively corresponding to two receiving control signals having a phase difference of 180° are reciprocal signals.

8. The detection device according to claim 7, wherein the circuit modulation signals respectively corresponding to the two receiving control signals having a phase difference of 90° have a first time interval, and are respectively converted into different electrical signals by the first circuit receiving the first modulation signal and the second circuit receiving the second modulation signal in the receiving portion.

9. The detection device according to claim 1, wherein the first circuit and the second circuit are connected to a same pixel unit and receive the first modulation signal and the second modulation signal to generate respective electrical signals.

10. The detection device according to claim 9, wherein the receiving portion comprises a plurality of the pixel units arranged in an array.

11. A detection method, applied to the detection device according to claim 1, the detection method comprising:
acquiring, by the receiving portion under the control of a control signal, the light amount of the light source reflected by the detected object, and generating, by the photoelectric conversion module in the receiving portion, corresponding photo-generated electrons according to the received light amount, wherein the receiving portion further comprises the first circuit and the second circuit each configured to convert the incident light into the electrical signal, the first circuit is configured to receive the first modulation signal and the second circuit is configured to receive the second modulation signal, and wherein the first circuit and the second circuit are configured to generate respective electrical signals according to the first modulation signal and the second modulation signal;
controlling, by the controller, the light source to emit the light to illuminate the detected object, and controlling, by the controller, the receiving portion to receive the plurality of receiving control signals having the same phase or different phases as the light signal emitted by the light source and acquire electrical signals corresponding to at least one of the receiving control signals having the same phase respectively by the two circuits; and
acquiring, by the information acquiring unit, the target information of the detected object according to the electrical signals corresponding to the at least one of the receiving control signals having the same phase respectively acquired by the two circuits.

12. The detection method according to claim 11, wherein the plurality of receiving control signals having the same phase or different phases as the light signal emitted by the light source are four receiving control signals having different phases.

13. The detection method according to claim 11, wherein in the process of acquiring the target information, the electrical signals corresponding to the receiving control signals having the same phase are at least summed.

14. The detection method according to claim 11, wherein the plurality of receiving control signals having the same phase or different phases comprise signals having four phases of 0°, 90°, 180° and 270°, and the light receiving portion acquires, for at least one of the receiving control signals having the phases, electrical signals corresponding to the reflected light of the same phase respectively by the two circuits.

15. The detection method according to claim 11, wherein the two circuits respectively acquires different electrical signals corresponding to each phase of the plurality of receiving control signals having the same phase or different phases.

16. The detection method according to claim 15, wherein the first modulation signal and the second modulation signal are reciprocal to each other in at least part of a time period.

17. The detection method according to claim 11, wherein the light source outputs the emitted light with a same duration for at least four times, and circuit modulation signals respectively corresponding to two receiving control signals having a phase difference of 180° are reciprocal signals.

18. The detection method according to claim 17, wherein the circuit modulation signals respectively corresponding to the two receiving control signals having a phase difference of 90° have a first time interval, and are respectively converted into different electrical signals by the first circuit receiving the first modulation signal and the second circuit receiving the second modulation signal in the receiving portion.

19. The detection method according to claim 11, wherein the first circuit and the second circuit are connected to a same pixel unit and receive the first modulation signal and the second modulation signal to generate respective electrical signals.

20. The detection method according to claim 19, wherein the receiving portion comprises a plurality of the pixel units arranged in an array.
